(19) United States
(12) Patent Application Publication
(10) Pub. No.: US 2002/0184404 A1
(43) Pub. Date: Dec. 5, 2002

(54) System and method of maintaining a timed event list

(76) Inventor: Kenneth Lerman, Newtown, CT (US)

Correspondence Address: LAHIVE & COCKFIELD, 28 STATE STREET, BOSTON, MA, 02109, US

(21) Appl. No.: 09/872,326

(22) Filed: Jun. 1, 2001

(51) Int. Cl. G06F 9/46; G06F 9/00

(52) U.S. Cl. 709/318

(57) ABSTRACT

A method for maintaining a timed event list is disclosed. The illustrative embodiment of the present invention provides a method of rapidly inserting, examining, rescheduling and executing events in a timed event list in a time critical manner. By limiting the time required to insert events into a timed event list, and further limiting the time required to retrieve events from a timed event list, the method of the present invention increases the time available to a system to process timed events.

### FIELD OF THE INVENTION

The illustrative embodiment of the present invention relates generally to maintaining a timed event list in an electronic device, and more specifically to maintaining a timed event list in an electronic device in a manner in which event insertion time into the list and event retrieval time from the list are not proportional to the size of the list.

### BACKGROUND OF THE INVENTION

Electronic devices function by executing operations such as processes, tasks, events, and threads (a lightweight process). The term “event” shall be used generally herein to include tasks, processes, events, threads and similar terms. When events are required to be performed by a certain time, they are referred to as scheduled or timed events. The timed events are stored in memory accessible to the electronic device in a list known as an event list. In order for the system to function properly, the events must be scheduled in the correct order. Existing events must be identified and executed on schedule. New events must be inserted into the event list in the proper location so that they maybe executed at the correct time. While the scheduling of events is important in every system, it takes on increased importance in electronic devices where the timely execution of events is of paramount importance, such as in real-time computer systems and in computer simulations.

The conventional method of maintaining a timed event list is to store individual events in a data structure known as a linked list. A linked list is a collection (i.e.: a list) of smaller data structures known as nodes. A node in a linked list includes a section for data and a section holding at least one pointer to a next node in the list. In doubly-linked lists, a section for a pointer to the previous node in the linked list is also included. A pointer is a value that identifies a memory location in the electronic device. The nodes in a linked list are often not stored in adjacent memory locations in the system and the pointers allow the list to appear as an uninterrupted structure. The initial node in the list is referred to as the “head node” and is pointed to by a separate pointer known as the “header pointer”. The last node in the list is referred to as the “tail node” and contains a pointer to a null reference, known as a “null pointer”. In some implementations the last node on the list also may be pointed to by a separate pointer known as a “tail pointer”. Linked lists are a widely used type of data structure because the memory requirements of the linked list does not need to be statically specified (the memory for a linked list is dynamically assigned as new nodes are added to the list ). A linked list with zero nodes in it is referred to as an empty linked list. In such a case the header pointer is a null pointer.

The conventional method of maintaining a timed event list requires the linked list to be sorted. Linked lists may be sorted through the use of “sort keys”. A sort key is a piece of data which is used to compare data contained in each of the individual nodes in the linked list. For example, timed event lists are sorted by the time of execution for the events which are recorded in the nodes of the linked list, so the sort key for the linked list would be the execution time of an event. The mechanisms used to sort a linked list are well known in the art. In order to rearrange a nodes position in the linked list, the pointer in the node and its surrounding node/nodes must be adjusted. Often this is accomplished through the use of a temporary node which serves as a holding spot for a pointer while the adjacent pointers are being re-oriented. A new node may be inserted into a linked list which has been sorted by event execution time by incrementally traversing the linked list and checking the execution time of the event in each node against the execution time of the event in the node being inserted. Once the proper insertion position has been located, the pointers of the nodes are readjusted and the new node is inserted between the appropriate existing nodes.

When it is applied to a timed event list, the conventional method of storing events in a linked list format has one major drawback. The method requires the serial traversal and inspection of the existing nodes in the linked list in order to insert a node with a new event. The linked list holding the timed events is sorted by time. Unfortunately, as the number of events in a timed event list grows larger, a larger portion of system time is spent traversing and inspecting the nodes in the linked list in a search for the proper insertion point. In electronic devices requiring the timely execution of events such as real-time computer systems and computer simulations this causes an unacceptable performance degradation.

### BRIEF DESCRIPTION OF THE DRAWINGS

FIG. 1 is a block diagram of an environment suitable for practicing an illustrative embodiment of the present invention;

FIG. 2 is a block diagram of a linked list;

FIG. 3A is an illustrative embodiment of the present invention utilizing an array and linked list combination to maintain a timed event list;

FIG. 3B is a block diagram of the illustrative embodiment of FIG. 3A at a later time;

FIG. 3C is a block diagram of the illustrative embodiment of FIG. 3B at a later time; and

FIG. 3D is a block diagram of the illustrative embodiment of FIG. 3C at a later time.

### DETAILED DESCRIPTION OF THE INVENTION

The illustrative embodiments of the present invention provide a method for maintaining a timed event list for suitable systems requiring time critical processing of scheduled events, such as the SN4000 switch from Sycamore Networks of Chelmsford, Mass. A rapid insertion method for new events creates more available time for processing scheduled events. By using a multitude of linked lists which are stored in an array and sorted by time through the use of a hashing algorithm, the illustrative embodiments of the present invention provide an insertion time that is independent of the number of events that have been scheduled. With less time spent searching for the proper event insertion point, the system is able to process more events in a timely manner.

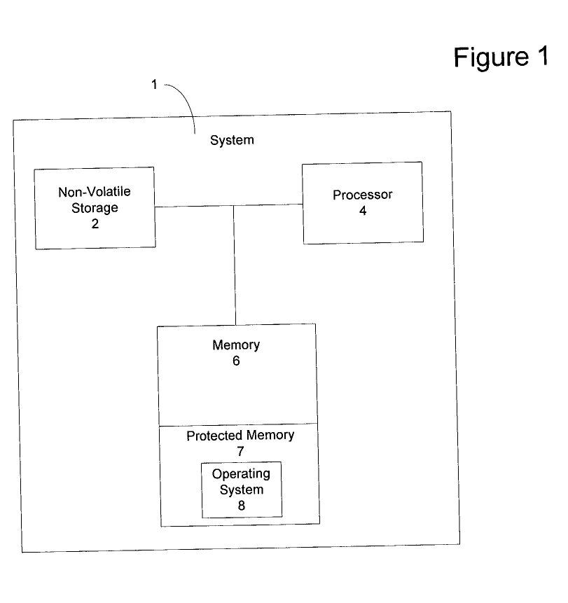

FIG. 1 depicts an environment suitable for practicing an illustrative embodiment of the present invention. The system 1 includes a non-volatile storage area 2, such as a hard drive. Also included in the system 1 is a processor 4 and a memory area 6. The memory 6 includes a protected area of memory 7, into which the operating system 8 for the system 1 is loaded. The protected area of memory 7 is used only by the operating system 8 and is unavailable to a system user or another application. The operating system 8 maintains a list of tasks or events for execution. Events must be scheduled onto the event list, retrieved from the event list, and performed in a timely manner.

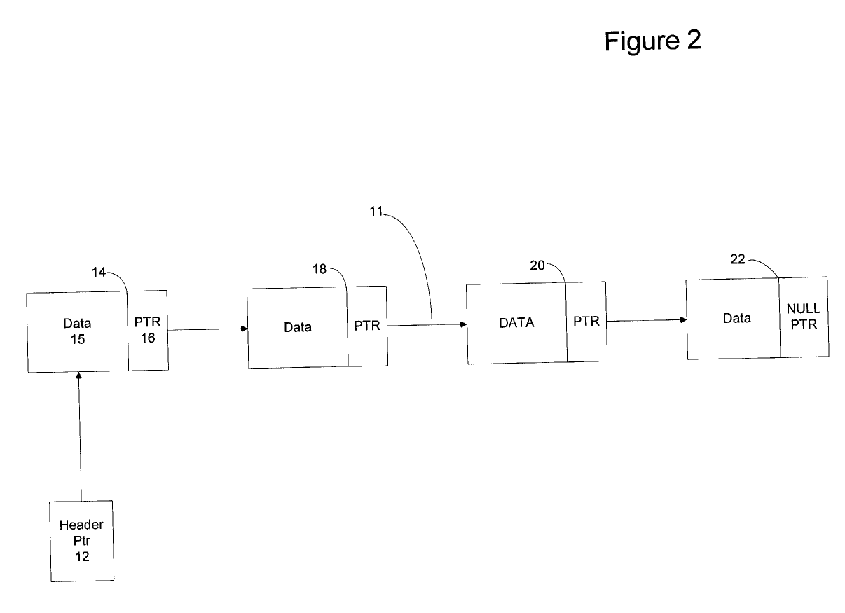

FIG. 2 depicts a linked list used in the illustrative embodiments of the present invention. The linked list 11 includes a head node 14, individual nodes 18 and 20, and a tail node 22. Each node contains a data section 15 and a pointer section 16. The data section 15 contains the data held by the node, such as a scheduled event with a start time. The pointer section 16 holds a pointer which points to the next node in the linked list. Each node is linked through a pointer to the next node in the linked list 11. Thus, the node 14 has a pointer that points to the next node 18. The node 18 includes a pointer that points to the next node 20. The pointer section of the the node 20 includes a pointer that points to the node 22. The final node 22 in the linked list 11 includes a pointer pointing to a null reference which indicates that the linked list is at an end. Each node is stored in a memory location in the memory 6 of the system 1. The linked list 11 is accessed through the header pointer 12 which points to the head node 14 in the linked list. In order to access nodes in the middle of a linked list, it is necessary to traverse the linked list from the end of the linked list to the node in question. Those skilled in the art will realize that in a double-linked list it is possible to traverse the linked list in both directions through the use of pointers pointing to the preceding and following nodes in the linked list.

Conventional methods of maintaining timed events in a linked list suffer from slow insertion times. Specifically, the time required to traverse the linked list to find the proper insertion point negatively impacts system performance. Likewise, the re-sorting of the linked list after every insertion point is found also slows system performance. The illustrative embodiment of the present invention avoids the slow insertion problem by using a plurality of linked lists in combination with an array. By using multiple linked lists in a large array, the linked lists are greatly shortened. Since the linked lists have a short length, the insertion may be done at the end of the linked list without having to sort each linked list. A pointer to the tail of the list allows immediate insertion. This provides great time savings to the system during the event insertion process. Since the events in the linked list must be accessed in a timely manner, the linked lists are inserted in an array and the array is sorted by time.

An array is a series of logically adjacent memory locations located in the memory 6 of the system 1. The memory locations all hold items of a same data type, such as integer values, pointers, or defined data structures. In one embodiment of the present invention, the array memory locations hold a data structure which includes a header pointer and a tail pointer to a linked list. The linked list may be traversed from the header node to examine data and new nodes may be inserted at the tail pointer. If the linked list is empty, the header pointer and tail pointers are null pointers. In another embodiment of the present invention, the array holds a tail pointer to a doubly linked list. The linked list may be traversed backwards from the tail to examine data and new nodes may be inserted at the tail of the linked list. Those skilled in the art will recognize that there are many different data structures which may be employed without departing from the scope of the present invention. The array is chosen to be a size much larger than the expected number of events occurring at any given time. The array is accessed through the array name which the operating system 8 cross-references to a given memory location, and an index which will be referred to herein as the “now pointer”. The index represents an offset from the array starting point. For example, if the now pointer has a value of 40, the memory location indicated by the now pointer is the starting point of the array offset by 40 memory locations. The now pointer is synchronized with the system clock and iterates to the next position in the array at predetermined time intervals, such as 10 milliseconds. As a result, each memory location pointed to by the now pointer represents the current time. The other memory locations in the array, modulo by the size of the array, such as 8192, represent future times. For example, if the now pointer was being advanced through the array every 10 milliseconds, and was currently at location 20, location 21 would represent the current time plus 10 milliseconds.

The illustrative embodiment of the present invention schedules an event by first inserting the event information, including the scheduled time for execution, into the data section of a node structure. The scheduled event time included in the data section of the node is compared against the current time indicated by the position of the now pointer in the array. The scheduled event time is subtracted from the current time (if the scheduled time equals the current time, the event is immediately executed). The difference from the subtraction operation represents how far in the future the event is scheduled to occur. The time differential is divided by the time parameter controlling the now pointer advancement, and the result has a modulo operation performed on it with the size of the array. Those skilled in the art will recognize the sequence of mathmatical operations performed to determine an insertion point for a new node as a “hashing algorithm.” For example, if the time differential were 300 milliseconds, the 300 milliseconds would be divided by the time parameter controlling the now pointer advancement, such as 10 milliseconds, to arrive at result of 30. The current array position indicated by the now pointer would have 30 added to it and the result would undergo a modulo operation using the size of the array, such as 8192, to determine the proper placement for the timed event. If there were more than 30 memory locations remaining between the positon of the now pointer and the end of the array, the node holding the timed event would be inserted in a the linked list referenced by the array location 30 memory locations from the current position. If, however, the now pointer was closer to the end of the array than 30 memory locations, the now pointer would advance as many locations as possible to the end of the array and then wrap around and continue counting from the beginning of the array to determine the insertion point.

As noted above, the array in the illustrative embodiment of the present invention is chosen to have many more memory locations than there are events occurring at any one time. The size of the array results in most of the memory locations referencing linked lists with one or zero nodes. The timed event node is inserted onto the end of the linked list referenced at the specified location. If the linked list referenced by the memory location is empty, the pointers in the array memory location are re-oriented to point directly to the new node. A null pointer is inserted into the pointer section for the new timed event node. If the linked list referenced by the array memory location already contains at least one node, the new timed event node will be inserted at the end of the current linked list by redirecting the null pointer in the final node of the linked list to the new timed event node. Again, the new timed event node will have a null pointer inserted into its pointer section. The linked list does not have to be sorted. Using this method, the illustrative embodiments of the present invention provide an expedited means of inserting new timed events into a timed event list.

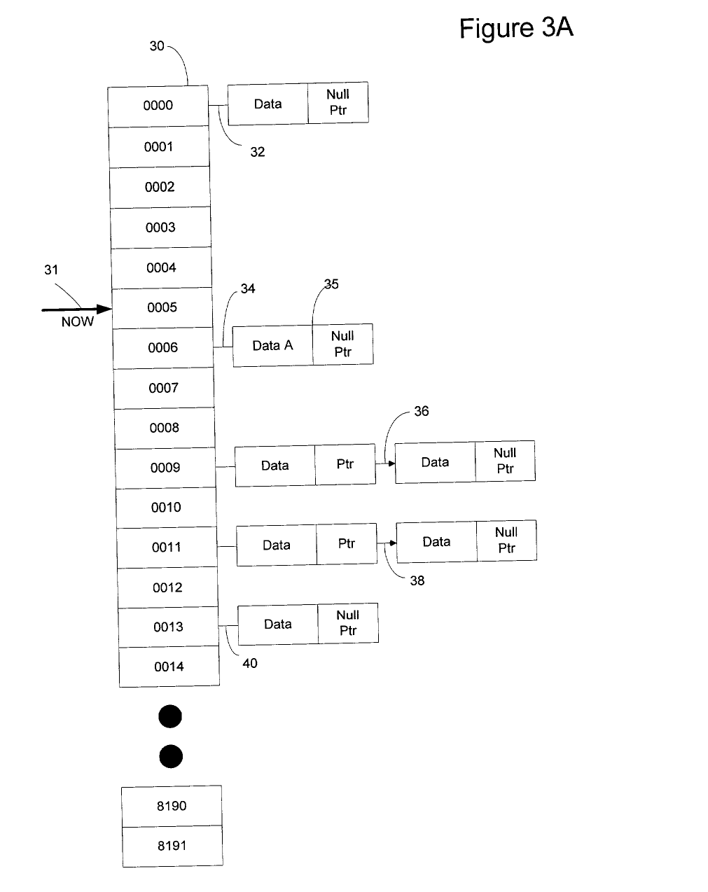

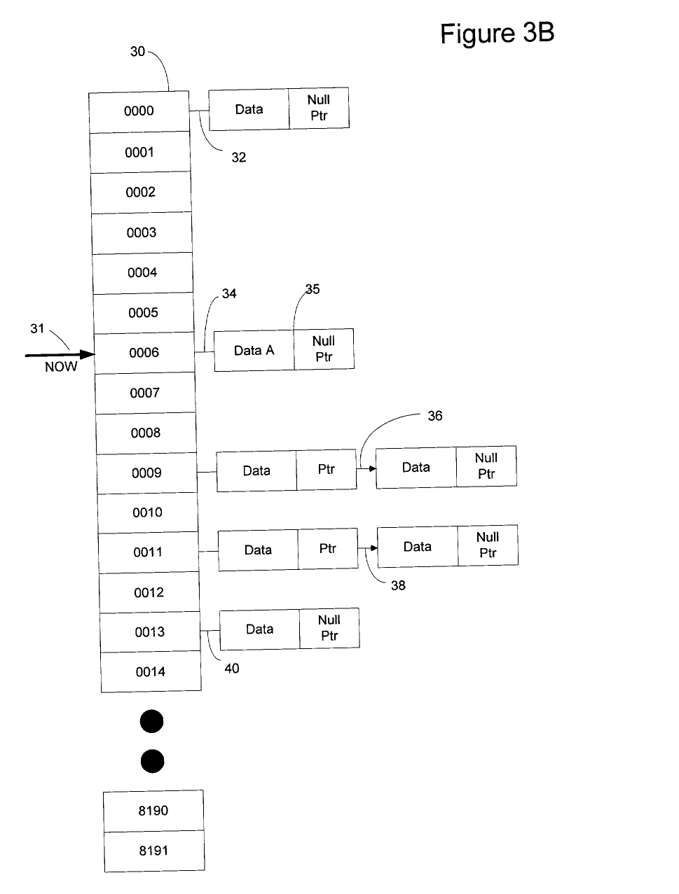

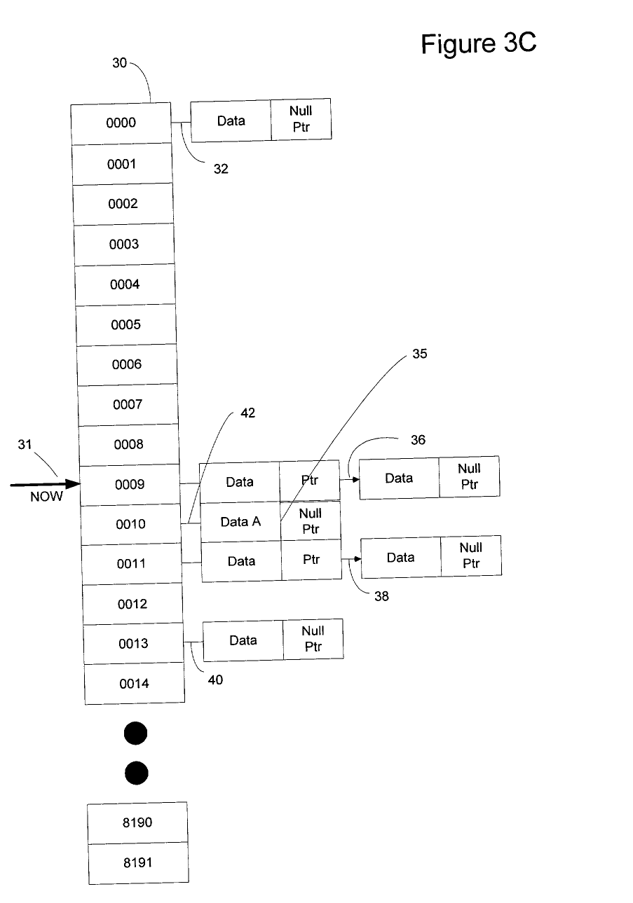

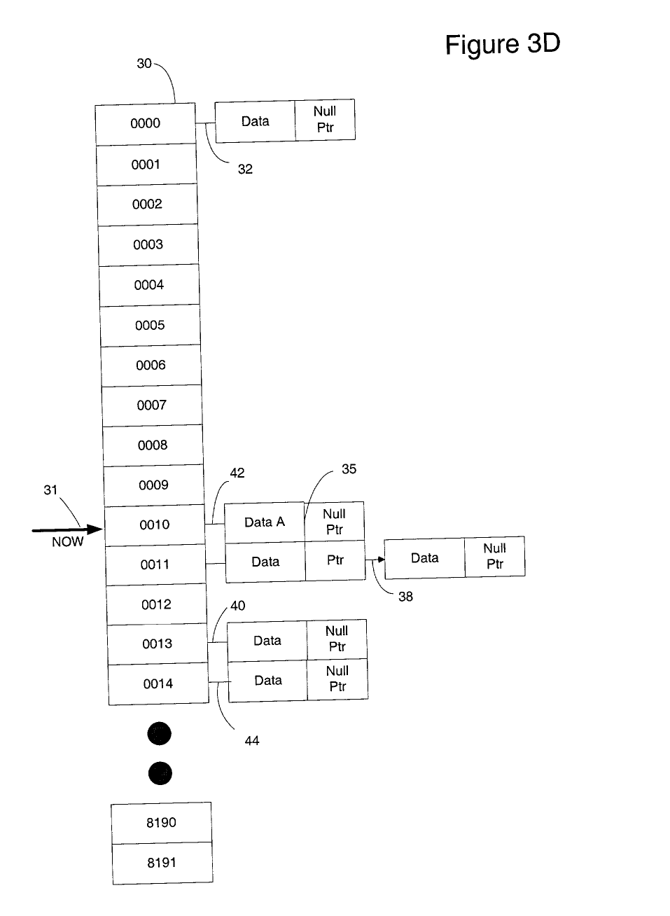

FIGS. 3A-3D illustrate the process of maintaining a timed event list in an illustrative embodiment of the present invention. FIG. 3A depicts the components used to process the timed event list of the illustrative embodiments. A system 1 includes an array 30 of adjacent memory locations numbered from 0 to 8,191, an array of 8,192 memory locations. Those skilled in the art will recognize that the size of each memory location, such as 1 byte, 2 bytes, or 4 bytes, will vary according to the system 1 being utilized. An array index, referred to as a now pointer 31 which is indicating memory location [0005], keeps track of the current location in the array and is synchronized with the system clock. The now pointer iterates through the array at predetermined intervals, such as advancing every 10 milliseconds. Included in some, but not all, of the memory locations in the array 30 are references to a plurality of linked lists 32, 34, 36, 38, and 40. The linked lists are composed of one or more nodes 35, which include a data section and a pointer section to the next node, if any, in the linked list. The data section contains the record of a timed event to be executed by the system 1.

FIG. 3B depicts the array 30 previously shown in FIG. 3A at a later time interval. The now pointer 31 has advanced to memory location [0006] of the array 30. During the time period the now pointer is pointing to the memory location, the method of the present invention will check for a linked list located at that location. The linked list 34, containing a node 35, is pointed to by a reference in memory location [0006], the current location in the array. The record of the timed event contained in the data section is examined to see if it indicates an event that is ready for execution. If the event included in the linked list referenced by the current array memory location is ready for execution, the system 1 executes the event. If the event is not ready for execution, the scheduled time is compared to the current time as detailed above, and the node is deleted from the linked list 34. The deleted node is reinserted into the array 30 at the memory location corresponding to its scheduled time for execution as explained above. Each node of the linked list is examined and either executed or removed and executed. Since there are more memory locations than events, the majority of memory locations will include references to linked lists that are either empty or have one node to examine.

FIG. 3C depicts the array 30 previously shown in FIG. 3A and FIG. 3B following the processing of the memory locations [0006],[0007] and [0008]. The now pointer 31 is now pointing to memory location [0009]. The node 35, which formerly was in linked list 34 when it was located at memory location [0006], has been rescheduled to memory location [0010] where it is attached to linked list 42, a previously empty linked list. The now pointer 31 examines linked list 36, as above, and either executes the timed event contained in each node or reschedules the node to the appropriate time, as outlined above.

FIG. 3D depicts the array 30 of FIGS. 3A-3C with the now pointer pointing to memory location [0010]. Node 35, which was previously examined and not executed, is now executed, as the scheduled time and the time referenced by the memory location are the same. New timed events or rescheduled events have been inserted into the linked list 44 at memory location 14. In real-time computer systems and computer simulations there are usually more events scheduled in the near future than later in time so that the linked lists referenced by the memory locations nearer the now pointer 31 are more likely to contain non-empty linked lists than those farther away (in space and time ).

The illustrative embodiment thus allows a rapid examination, execution, and rescheduling of timed events. The overhead required to process the timed event list is less than that used in conventional methods which allows the system to process scheduled events in a time critical manner.

It will thus be seen that the invention attains the objects made apparent from the preceding description. Since certain changes may be made without departing from the scope of the present invention, it is intended that all matter contained in the above description or shown in the accompanying drawings be interpreted as illustrative and not in a literal sense. Practitioners of the art will realize that the system configurations depicted and described herein are examples of multiple possible system configurations that fall within the scope of the current invention. Likewise, the types of data structures noted in the drawings and description are examples and not the exclusive types of data structures which may be employed within the scope of the present invention.

We claim:

1. In an electronic device, a method for maintaining a timed-event list of operations to be performed by said electronic device, said method, comprising the steps of:
providing a first data structure, said data structure of a size larger than the expected number of events occurring in said electronic device at any one time,
providing a plurality of second data structures referenced by said first data structure, said second data structures holding third structures, each said third structure encapsulating data about a timed event, said timed events to be performed by said electronic device,
inserting a third structure into a selected one of said second data structures referenced by said first data structure, said selected one of said second data structures selected based on the time for execution of a timed event encapsulated by said third structure, the size of said first data structure and a current time.

2. The method of claim 1 comprising the further step of:
serially traversing said first data structure at periodic timed intervals.

3. The method of claim 2 comprising the further steps of:
serially traversing a second data structure referenced by said first data structure in the time period between said periodic timed intervals; and
inspecting a third structure held by said second data structure.

4. The method of claim 3 comprising the additional steps of:
retrieving said inspected third structure from said second data structure; and
executing a timed event encapsulated by said third structure.

5. The method of claim 3 comprising the further steps of:
removing said inspected third structure from said second data structure; and
inserting said inspected third structure into a different second data structure referenced by said first data structure based on the time for execution of a timed event encapsulated by said third structure, the size of said first data structure and a current time.

6. The method of claim 5 comprising the further steps of:
retrieving said inspected third structure from said second data structure; and
executing a timed event encapsulated by said third structure.

7. The method of claim 3 wherein said first data structure is an array.

8. The method of claim 3 wherein said plurality of said second data structures are linked lists.

9. The method of claim 3 wherein said plurality of said second data structure are doubly-linked lists.

10. The method of claim 3 wherein said third structure encapsulates data about a timed event that is part of a computer simulation.

11. The method of claim 1 wherein said electronic device is a real-time computer system.

12. The method of claim 1 wherein said electronic device is a network switch.

13. The method of claim 1 wherein a hashing algorithm is used to select the insertion point of said third structure.

14. In a computer system, a method for maintaining a timed-event list, said method, comprising the steps of:
providing an array of memory locations, said memory locations numbering more than the expected number of events occurring in said computer system at any one time,
providing a plurality of linked lists referenced by said memory locations in said array, said linked lists including nodes, each said node encapsulating data about a timed event to be performed by said computer system;
inserting a node into a selected one of said linked lists referenced by said memory locations in said array, said selected one of said linked lists selected based on the time for execution of a timed event encapsulated in said node, the size of said array and a current time.

15. The method of claim 14 wherein said linked lists are doubly-linked lists.

16. The method of claim 14 comprising the further step of:
serially traversing said array at periodic timed intervals.

17. The method of claim 16 comprising the further steps of:
serially traversing a linked list referenced by said memory locations in said array; and
inspecting a node in said linked list encapsulating data about a timed event.

18. The method of claim 17 comprising the further steps of:
retrieving said inspected node from said linked list; and
executing a timed event encapsulated by said inspected node.

19. The method of claim 17 comprising the further steps of:
removing said inspected node from said linked list; and
inserting said inspected node into into a different linked list referenced by a different memory location in said array based on the time for execution of a timed event encapsulated by said inspected node, the size of said first data structure and a current time.

20. The method of claim 19 comprising the further steps of:
retrieving said inspected node from said different linked list; and executing a timed event encapsulated by said inspected node.

21. The method of claim 14 wherein said computer system is a real-time system.

22. The method of claim 14 wherein said timed event list holds events for a computer simulation.

23. In a system, a medium holding computer-executable instructions for a method, said method, comprising the steps of:
providing a first data structure, said data structure of a size larger than the expected number of events occurring in said system at any one time,
providing a plurality of second data structures referenced by said first data structure, said second data structures holding third structures, each said third structure encapsulating data about a timed event, said timed events to be performed by said system,
inserting a third structure into a selected one of said second data structures referenced by said first data structure, said selected one of said second data structures selected based on the time for execution of a timed event encapsulated by said third structure, the size of said first data structure and the current time.

24. The method of claim 23 comprising the further step of:
serially traversing said first data structure at periodic timed intervals.

25. The method of claim 24 comprising the further steps of:
serially traversing a second data structure referenced by said first data structure in the time period between said periodic timed intervals; and
inspecting a third structure in said second data structure, said third structure encapsulating information about a timed event.

26. The method of claim 25 comprising the additional steps of:
retrieving said inspected third structure from said second data structure; and
executing a timed event encapsulated by said third structure.

27. The method of claim 25 comprising the further steps of:
removing said inspected third structure from said second data structure; and
inserting said inspected third structure into a different second data structure referenced by said first data structure based on the time for execution of a timed event encapsulated by said third structure, the size of said first data structure and the current time.

28. The method of claim 27 comprising the further steps of:
retrieving said third structure from said second data structure; and
executing a timed event encapsulated by said third structure.

29. In an optical network, a switching apparatus comprising:
a processor;
an event list, said event list comprised of a first data structure holding references to a plurality of second data structures, said second data structures holding third structures, said third structures encapsulating information about events scheduled to be executed by said switching apparatus; and
a management facility for maintaining said event list, said management facility inserting third structures into selected second data structures referenced by said first data structures based on the time for execution of a timed event encapsulated by said third structure, the size of said first data structure and a current time.

30. The apparatus of claim 29 wherein said first data structure is an array

31. The apparatus of claim 29 wherein said second data structure is a linked list.

32. The apparatus of claim 29 wherein said second data structure is a doubly-linked list.
